(19) United States
(12) Patent Application Publication
(10) Pub. No.: US 2026/0252980 A1
(43) Pub. Date: Aug. 27, 2026

(54) WORKFORCE MANAGEMENT CONFIGURATION COMPLIANCE ENGINE POWERED BY GENERATIVE ARTIFICIAL INTELLIGENCE

(71) Applicant: NICE LTD., Ra'anana (IL)

(72) Inventors: Vaibhav CHOBE, Pune (IN); Gurprit JOHAL, Pune (IN); Gaurav SURYAWANSHI, Pune (IN)

(21) Appl. No.: 19/063,580

(22) Filed: Feb. 26, 2025

(51) Int. Cl. G06Q 10/0631; G06Q 10/109

(52) U.S. Cl. CPC G06Q 10/06311; G06Q 10/109

(57) ABSTRACT

A workforce compliance system and methods for ensuring workforce compliance include receiving a notification that a first workforce management (WFM) configuration for an agent was created or updated; retrieving details of the agent, the first WFM configuration of the agent, and a schedule unit of the agent; extracting a geographic location of the agent from the schedule unit of the agent; generating a first prompt based on the geographic location of the agent and the first WFM configuration of the agent; executing the first prompt via a large language model (LLM); and displaying, on a WFM administrative interface, the compliance status of the first WFM configuration and the one or more insights based on the compliance status.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to complying with labor laws and regulations, and more specifically to systems and methods that leverage generative artificial intelligence (AI) to automate compliance tasks, reduce manual errors, and provide actionable insights to workforce management administrators.

### BACKGROUND

Compliance with labor laws is a cornerstone of effective workforce management (WFM), yet it presents significant challenges. For example, organizations operating across multiple regions or globally face immense complexity in adhering to diverse labor laws. Each region has distinct regulations governing aspects like maximum working hours, break requirements, time-off policies, and overtime limits. This variability necessitates tailored compliance configurations, complicating the creation of uniform policies. Additionally, labor laws and regulations undergo frequent updates or revisions. Keeping pace with these changes requires continuous monitoring and timely updates to the system. In a manual setup, this dynamic nature can overwhelm WFM administrators and increase the risk of non-compliance.

Reliance on manual processes also introduces inefficiencies and risks that hinder compliance management. Manually interpreting and applying compliance rules increases the potential for errors. Missteps in configuration can result in inadvertent violations, exposing the organization to legal penalties, strained employee relations, and reputational damage. The effort required to review, understand, and implement compliance rules consumes considerable time and resources. This prolonged process delays workforce planning and distracts WFM administrators from higher-value tasks.

Moreover, the lack of automation exacerbates inconsistencies and risks. Compliance enforcement often relies on the vigilance and expertise of WFM administrators, which can lead to variability in how rules are applied. This inconsistency undermines the effectiveness of compliance measures. Many WFM systems address compliance reactively, resolving violations only after they occur. This approach increases the cost of corrections and leaves organizations vulnerable to avoidable risks.

Without intelligent tools, administrators struggle to balance compliance with operational goals. WFM systems often lack the capability to provide actionable insights or recommendations, leaving administrators to make decisions without adequate contextual support. This gap hinders the optimization of configurations to align with compliance and business objectives. Interpreting complex legal language and applying it accurately to WFM configurations is a daunting task, particularly when legal rules are ambiguous or conflicting. This challenge increases the likelihood of errors and suboptimal configurations.

Accordingly, there is a need for improved methods and systems for compliance management with labor laws and regulations to minimize or even avoid costly fines and penalties and to minimize or avoid supervisory attention that can be directed to other beneficial tasks, such as customer service and agent training.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a workforce compliance system according to various aspects of the present disclosure.

FIG. 2 illustrates a method for generating agent work rules and schedules automatically according to various aspects of the present disclosure.

FIG. 3 illustrates a method for validating WFM configurations against local labor laws, policies, and/or regulations according to various aspects of the present disclosure.

FIG. 4A illustrates an LLM prompt according to various aspects of the present disclosure.

FIG. 4B illustrates a response to the LLM prompt of FIG. 4A according to various aspects of the present disclosure.

FIG. 4C illustrates a comparison of a field in the response of FIG. 4B with an existing WFM configuration according to various aspects of the present disclosure.

FIG. 4D illustrates a recommendation or suggestion to modify the WFM configuration based on the comparison in FIG. 4C according to various aspects of the present disclosure.

FIG. 5A illustrates another LLM prompt according to various aspects of the present disclosure.

FIG. 5B illustrates the response to the LLM prompt of FIG. 5A according to various aspects of the present disclosure.

FIG. 6 is a flowchart of a method according to various embodiments of the present disclosure.

FIG. 6 illustrates that identifying the customer issue is based on the system prompt and the transcript of an ongoing interaction, according to various aspects of the present disclosure.

FIG. 7 illustrates a WFM administrative interface according to various aspects of the present disclosure.

FIG. 8 is a block diagram of a computer system suitable for implementing one or more components in FIG. 1, according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods address the challenges of compliance management by proposing a WFM configuration platform powered by generative AI. This solution aims to automate compliance tasks, reduce manual errors, and provide actionable insights for WFM administrators, thereby ensuring consistent adherence to labor laws across geographic regions, e.g., a country, state, province, county, city, and other such governmental administrative divisions.

The platform described herein leverages generative AI to automatically retrieve and apply geographic compliance rules based on the Scheduling Unit (SU) of an agent. This eliminates the need for manual interpretation of region-specific labor laws. By integrating AI-powered compliance validation and suggestion mechanisms, the platform not only automates traditionally manual processes, but also enhances the decision-making capabilities of WFM administrators with human-friendly, context-aware explanations. This approach represents a significant advancement in the way WFM systems handle compliance, offering a proactive, intelligent and user-centric approach solution.

An intuitive interface enables WFM administrators to review existing compliance rules, modify or update rules as needed to reflect organizational requirements or new regulations, and add custom rules for unique cases or exceptions.

The platform introduces intelligent validation mechanisms during onboarding and configuration updates to proactively identify and resolve compliance issues. Daily rule checks may be used to validate maximum daily working hours for each schedule, which may advantageously also permit updating legal changes on a daily basis and incorporating these into compliance requirements. Weekly rule checks ensure compliance with maximum weekly working hours, and provide AI-powered suggestions and contextual explanations to facilitate adjustments. The use of AI suggests appropriate values when violations are detected. Human-friendly explanations are preferably generated to aid administrators in understanding and resolution of any flagged potential or actual violations.

Furthermore, the present systems and methods validate compliance with operational hours, and check agent availability, minimum/maximum work hours, and consecutive on/off days to align schedules with labor regulations. Compliance with time-off policies, including paid time off (PTO), sick leave, and carry-forward rules are monitored. Guidelines for availing extra working hours are enforced, ensuring they align with organizational policies and labor laws.

Advantageously, insights and recommendations are generated by AI to provide contextual recommendations for compliance configurations based on regional and organizational standards. Complex compliance rules are translated into user-friendly suggestions, enabling faster and more accurate decision-making.

Furthermore, there is on-demand and continuous validation. Compliance checks as part of the system setup are run for new agent SUs or configurations. Compliance when administrators save or update configurations is thus ensured, reducing the risk of post-facto corrections.

The present disclosure provides a solution that significantly reduces the manual effort required to ensure compliance across various geographic regions, thereby minimizing the risk of non-compliance and potential resulting legal repercussions. By automating the retrieval and application of compliance rules, the present disclosure enhances the accuracy of WFM configurations and ensures that they align with regional labor laws. The AI-powered suggestions and explanations provide valuable insights to WFM administrators, leading to more informed decision-making and optimized WFM. Ultimately, this all results in increased efficiency, reduced operational costs, and a more compliant and resilient WFM system.

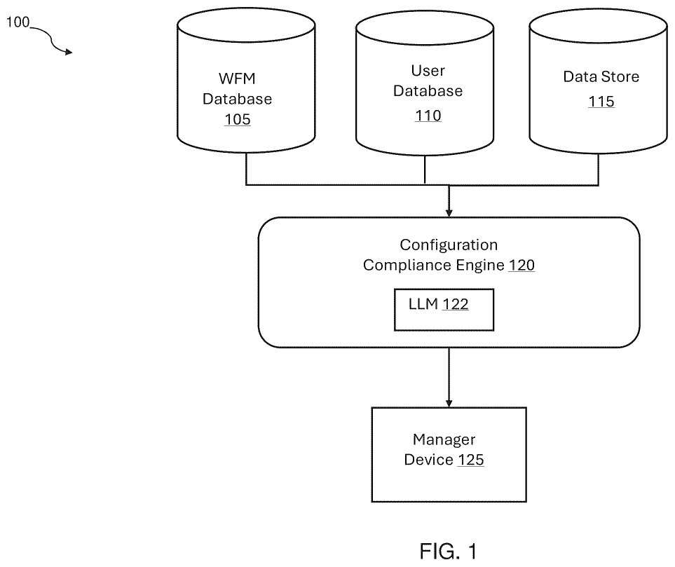

FIG. 1 illustrates a workforce compliance system 100 according to various aspects of the present disclosure. The system 100 includes WFM database 105, user database 110, data store 115, configuration compliance engine 120 (including large language model or LLM 122), and manager device 125. The WFM database 105 and the user database 110 act as the data sources containing configuration settings for the WFM system and the locations (i.e., geographic region(s), or geographic settings within the WFM system) where these configurations are applied. The databases 105 and 110 also provide input data about operational configurations that should be or need to be checked for compliance.

WFM database 105 stores all existing WFM configurations. WFM configurations include current assignments, policies, and rules. In some embodiments, the rules include daily and weekly work rules, such as maximum working hours, break requirements, and other operational guidelines.

User database 110 stores agent-specific details such as personal information and role, SU details, and current and preferred working locations. In certain embodiments, the agent details include agent schedules, availability, and preferences. The agent's SU specifies the geographic or organizational unit where the agent operates, which determines the applicable labor laws and compliance rules.

Data store 115 contains compliance policies and standards against which the configurations are validated, as well as historical data and insights for informed decision making. In various embodiments, data store 115 contains sets of labor compliance rules and regulations that apply to specific geographic locations of the agents. In certain embodiments, these sets of labor compliance rules and regulations are periodically updated to the most recent rules and regulations.

Configuration compliance engine 120 processes input data from WFM database 105 and user database 110 to analyze and validate configurations against the labor policies in data store 115. Configuration compliance engine 120 is responsible for formulating prompts or queries based on the configuration data. Prompts are structured inputs designed to query the LLM 122 effectively, enabling it to assess compliance status or identify issues. In one or more embodiments, configuration compliance engine 120 prepares structured prompts based on input data and compliance requirements. The prompts are tailored to query the LLM 122 effectively, ensuring that relevant labor and/or break policies are evaluated.

In addition, in various embodiments, configuration compliance engine 120 conducts a comprehensive analysis of WFM configurations against retrieved compliance rules. Configuration compliance engine 120 checks for potential violations such as breaches of daily or weekly maximum hours, non-adherence to mandatory breaks, and inconsistencies in time-off. The validation process identifies gaps and generates actionable insights and recommendations. In one or more embodiments, the validated configurations, along with actionable insights, are sent back to WFM database 105 for implementation.

In one or more embodiments, configuration compliance engine 120 serves as the core processing module that orchestrates the compliance check process. It obtains input data from the WFM configuration and integrates it with pre-stored compliance rules or policies retrieved from data store 115. It also identifies configurations requiring compliance validation.

LLM 122 interprets complex labor laws and policies specific to the agent's SU, provides human-readable insights and recommendations to manager device 125, and supports dynamic updates to compliance rules, ensuring they remain current with legal as well as organizational policy changes. LLM 122 is an advanced AI-based language model (e.g., GPT) tasked with analyzing the prompts generated by the system 100. It evaluates configuration settings against compliance policies and industry best practices. LLM 122 also outputs insights that include compliance status and recommendations for corrective actions, if necessary.

Manager device 125 allows managers and supervisors to review, modify, and approve WFM configurations, creating a continuous feedback loop that ensures compliance is maintained. The final output generated by the system 100 is displayed on manager device 125. Manager device 125 displays detailed compliance status reports and actionable insights for rectifying non-compliant configurations. The status reports are presented to end users or system administrators for decision-making on manager device 125.

In a sample workflow, system 100 begins by gathering WFM configuration details and associated location data. Configuration compliance engine 120 processes these inputs and retrieves relevant compliance rules from data store 115. Based on the configuration data and compliance rules, the system 100 generates specific prompts to facilitate LLM analysis. LLM 122 processes the prompts to evaluate configurations against compliance criteria. For example, LLM 122 identifies deviations, highlights potential risks, and suggests corrective actions. The results from LLM 122 are compiled into a comprehensive compliance report, including actionable insights. The output is delivered to administrators on manager device 125 for review and action.

In an exemplary embodiment, WFM settings such as schedules, shifts, and policies from agents are retrieved by configuration compliance engine 120 from WFM database 105 and agent details, such as their IDs and SUs are retrieved by configuration compliance engine 115 from user database 110. The WFM configuration details and agent-specific data is combined into a unified format. This ensures that the agent's working location (extracted from the SU) and schedule details are correctly linked to the configuration details.

Configuration compliance engine 120 also retrieves location-specific working policies, rules, and regulations from data store 115 and compares the WFM configuration against those policies, rules, and regulations by analyzing pre-defined policies such as work hours, shifts, and legal or operational constraints per location. Configuration compliance engine 120 determines if the configuration adheres to all location-specific policies. If the WFM configuration is compliant, the compliant configuration is saved and assigned to the respective agent. If the WFM configuration is non-compliant, configuration compliance engine 120 generates a detailed report of discrepancies. The report generally also prepares suggestions to make the WFM configuration compliant. It identifies the exact rules or policies violated and then formulates adjustments, such as modifying agent schedules, changing work locations or shifts, and updating resource allocations. Configuration compliance engine 120 converts these corrections into structured recommendations for review.

In several embodiments, configuration compliance engine 120 generates an AI-friendly prompt that includes the current WFM configuration details, any identified discrepancies, location-specific policies, and structured recommendations for corrections. The prompt is provided to LLM 122. LLM 122 provides either (1) a confirmation of compliance or (2) actionable suggestions to ensure the WFM configuration aligns with location-specific policies.

In one or more embodiments, manager device 125 displays the compliance status (i.e., compliant or non-compliant). If the configuration is compliant, then the manager device 125 indicates that no further action is needed. If the configuration is non-compliant, then the manager device 125 displays suggested adjustments and changes provided by LLM 122, and provides actionable feedback to implement these corrections.

Advantageously, automation of compliance management minimizes manual intervention by automating rule validation and configuration adjustment. The present disclosure dynamically retrieves labor laws and compliance rules based on the SU, ensuring global applicability of the system based on location of each agent and any other legally-required factors. LLM 122 generates clear, human-readable messages, making it easier for WFM administrators to understand and act on recommendations. Compliance configuration engine 120 works in tandem with client systems, ensuring a cohesive user experience. The present disclosure identifies compliance issues before they become violations, reducing legal and operational risks. The present algorithms provide a robust and scalable solution for automating compliance management in workforce scheduling, leveraging AI to bridge the gap between complex labor laws and practical WFM configurations.

Moreover, the present disclosure handles errors in database queries gracefully, such as missing agent details or policy definitions. Users are notified of missing or incomplete input data. In various embodiments, the algorithm can accommodate multiple agents and locations by batching data aggregation and validation steps. The present systems and methods are extendable to include additional policies or constraints as needed. The present disclosure maintains logs for all compliance checks, updates, and AI-generated suggestions. This is useful for tracking changes and generating reports for audit purposes. The present disclosure further includes an optional feedback loop for the AI-generated output, which allows users to tweak the suggestions or rerun validations with updated inputs. The algorithm provides a robust solution to manage and validate WFM configurations against location-specific policies and/or laws. By leveraging automation, database queries, and AI capabilities, it ensures that all configurations are optimized and compliant, reducing manual effort and increasing operational efficiency.

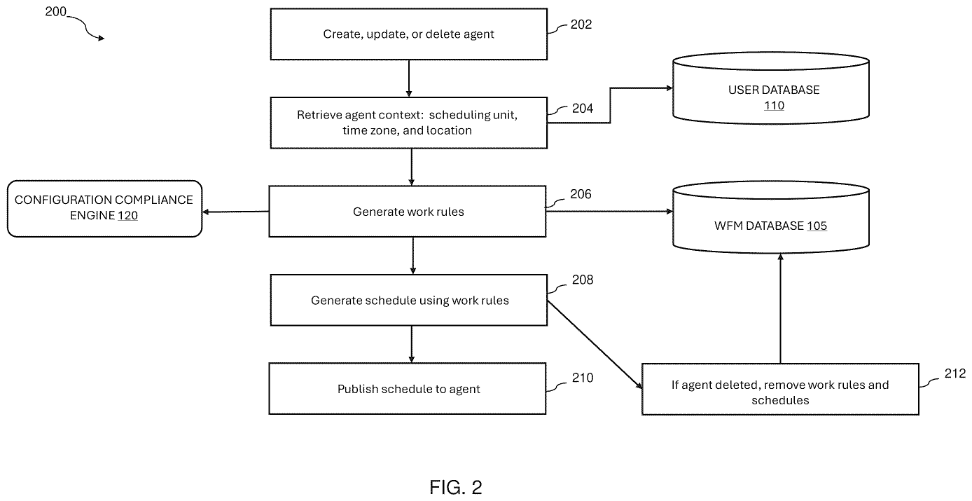

FIG. 2 illustrates a method 200 for generating agent work rules and schedules automatically according to embodiments of the present disclosure. When an agent's information is created, updated, or deleted in the system 100 in step 202 by a supervisor, the method 200 is triggered. The system 100 determines the agent context in step 204 by retrieving the agent's SU and the SU's time zone from user database 110, and identifies the geographic location associated with the time zone. Next, the system 100 calls configuration compliance engine 120 in step 206 to generate work rules with the agent details (e.g., ID, role, configuration), SU, time zone, and geographic location. Configuration compliance engine 120 generates agent-specific work rules. The generated work rules are saved in WFM database 105, and the work rules are associated with the agent for scheduling purposes. In step 208, the work rules are used to generate the agent's schedule. The work schedule is then validated against compliance requirements. The schedule is also published to the agent in step 210. Relevant stakeholders are notified about the schedule update. If an agent's profile is deleted, the associated work rules and schedules are also removed in step 212.

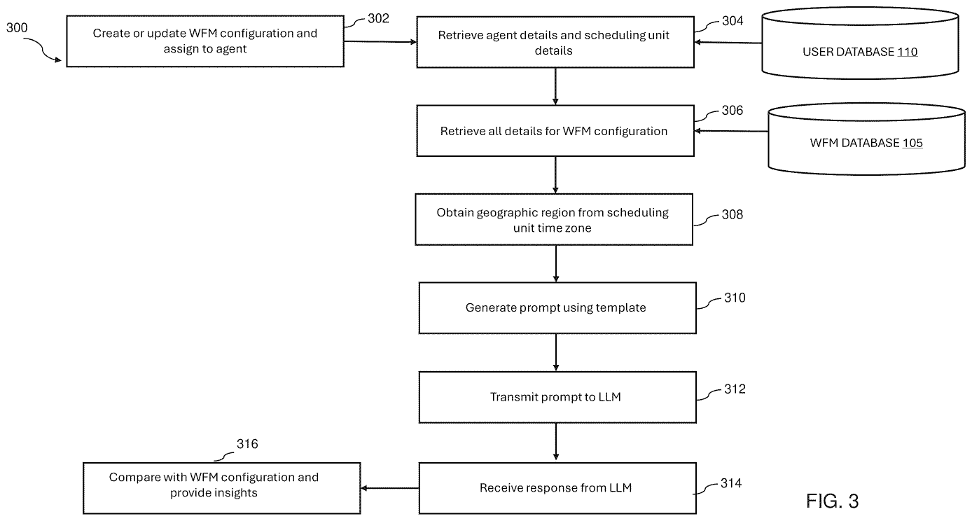

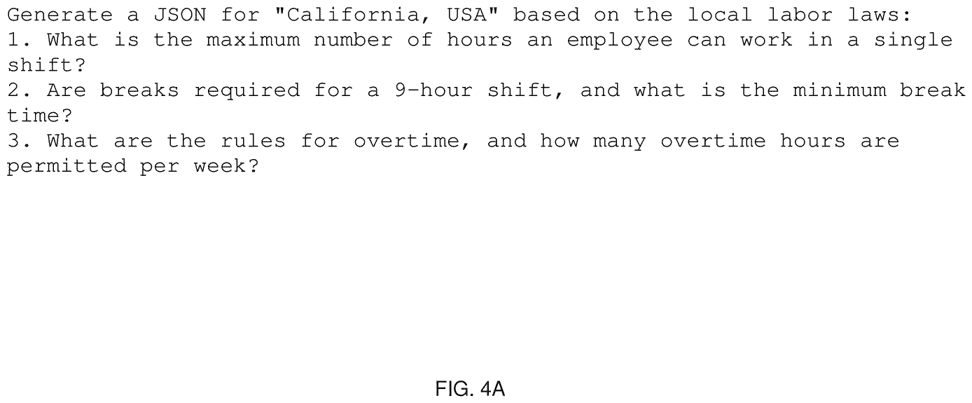

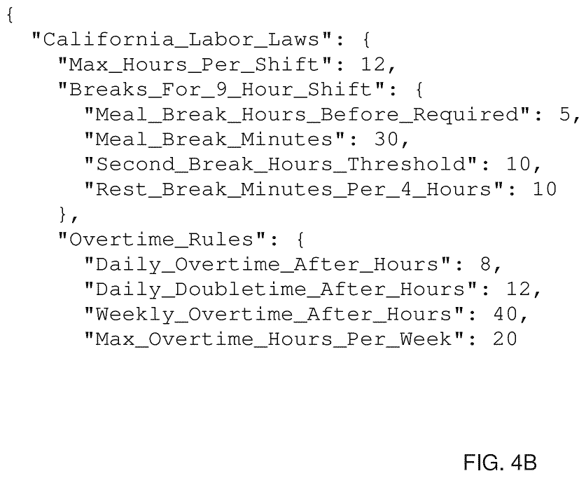

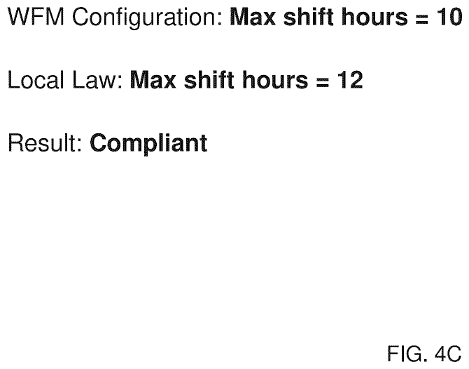

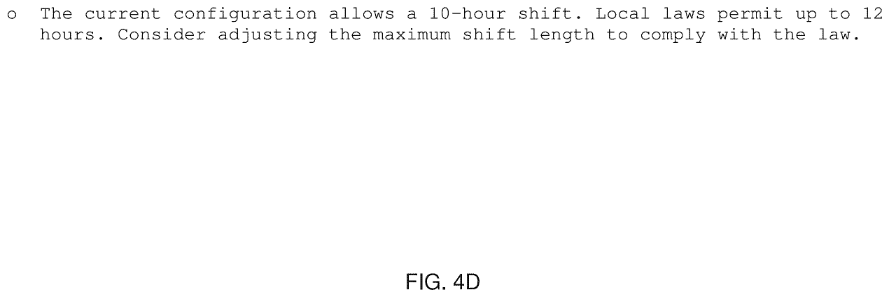

FIG. 3 illustrates a method 300 for validating WFM configurations against local labor laws, policies, and/or regulations. In step 302, a supervisor creates, updates, or deletes a WFM configuration and assigns it to an agent. This action kicks off the workflow. From the user database 110, agent details (e.g., name, ID, and preferences) are retrieved, as well as the SU information associated with the agent in step 304. From the WFM database 105, assigned configuration details like work hours, shift lengths, and breaks are retrieved in step 306. The time zone and geographic region is extracted from the SU, and the time zone is mapped to its geographic location in step 308. A structured prompt is created in step 310 based on the geographic location and compliance queries such as maximum hours per shift, break requirements for specific shift durations, and overtime rules and weekly overtime limits. An exemplary prompt is provided in FIG. 4A. The prompt is sent to a generative AI LLM 122 in step 312, such as GPT, to retrieve accurate labor law information from data store 115. The response from LLM 122 is received in step 314. An exemplary response is provided in FIG. 4B. LLM 122 compares each field in the response with the existing WFM configuration assigned to the agent in step 316. An exemplary comparison is shown in FIG. 4C. If any mismatch is detected, suggestions are provided to modify the configuration. Once compliance is ensured, agent-specific schedules are generated using the validated configurations, and the schedules are published for agents to view. FIG. 4D provides a recommendation or suggestion to modify the WFM configuration.

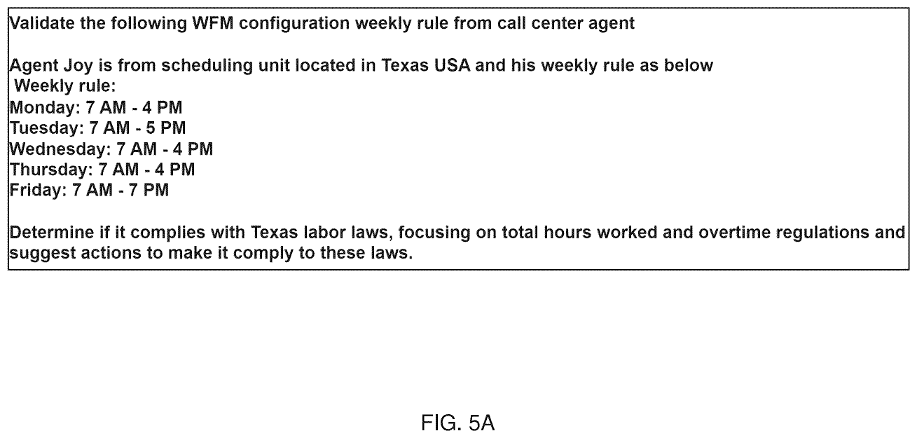

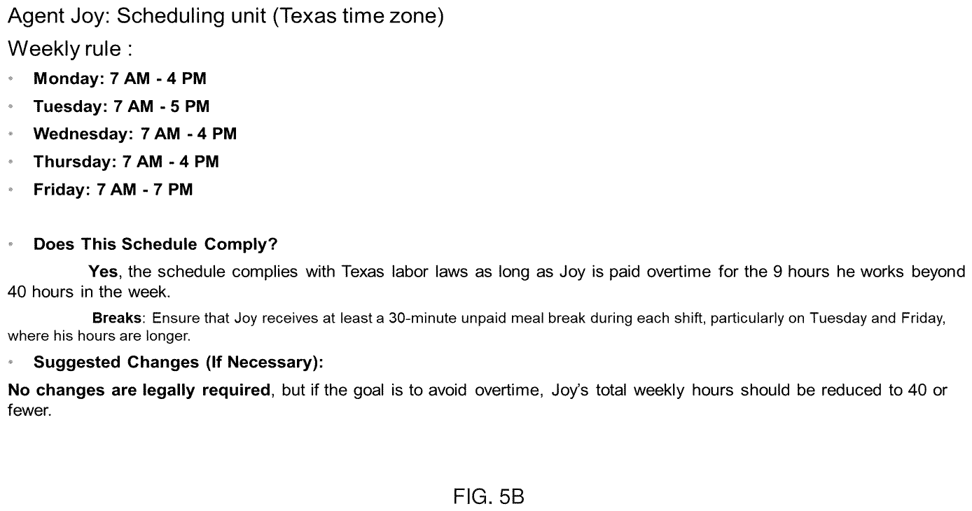

FIG. 5A illustrates another example of a prompt. To generate a prompt, agent details and the agent SU are retrieved to determine the agent's geographic location. The WFM configuration (e.g., weekly rule configuration) is obtained, and together with the agent's geographic location, is used to create the prompt. LLM 122 validates if the given weekly rule configuration for the agent working at the geographic location complies with relevant labor laws and working policies.

FIG. 5B illustrates the output of LLM 122. The output includes whether the weekly rule configuration complies with relevant labor laws and regulations and provides any suggested changes.

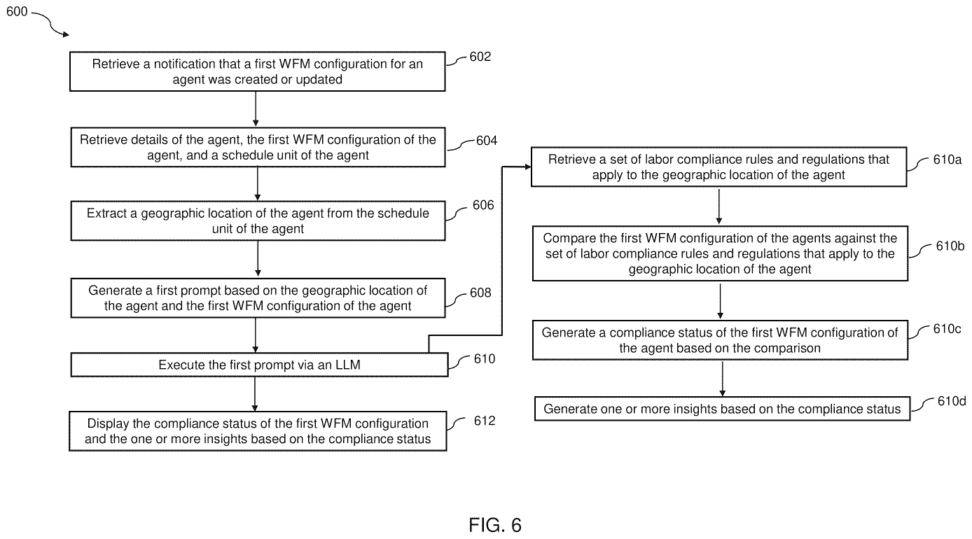

Referring now to FIG. 6, a method 600 according to embodiments of the present disclosure is described. At step 602, configuration compliance engine 120 receives a notification that a first WFM configuration for an agent was created or updated. In several embodiments, the first WFM configuration includes daily work rules, weekly work rules, time-off rules, and extra-hours rules.

At step 604, configuration compliance engine 120 retrieves details of the agent, the first WFM configuration of the agent, and a SU of the agent.

At step 606, configuration compliance engine 120 extracts a geographic location of the agent from the SU of the agent.

At step 608, configuration compliance engine 120 generates a first prompt based on the geographic location of the agent and the first WFM configuration of the agent. In some embodiments, the first prompt includes a daily work rule or a weekly work rule from the first WFM configuration and the geographic location of the agent. In various embodiments, the first prompt includes a query regarding a maximum number of hours, breaks, and/or overtime for the geographic location of the agent.

At step 610, configuration compliance engine 120 executes the first prompt via LLM 122. At step 610a, LLM 122 retrieves a set of labor compliance rules and regulations that apply to the geographic location of the agent. At step 610b, LLM 122 compares the first WFM configuration of the agent against the set of labor compliance rules and regulations that apply to the geographic location of the agent.

At step 610c, LLM 122 generates a compliance status of the first WFM configuration of the agent based on the comparison. In one or more embodiments, the compliance status includes a non-compliant WFM configuration and the one or more insights include a corrective action. In embodiments where the WFM configuration is non-compliant, the method 600 can additionally include receiving a second WFM configuration of the agent that is based on the corrective action; generating a second prompt from the geographic location of the agent and the second WFM configuration of the agent; executing the second prompt via the LLM 122 by: comparing the second WFM configuration of the agent against the set of labor compliance rules and regulations that apply to the geographic location of the agent, and validating that the second WFM configuration complies with the set of labor compliance rules and regulations that apply to the geographic location of the agent; saving the second WFM configuration; and assigning the second WFM configuration to the agent.

In some embodiments, the compliance status includes a compliant WFM configuration, and the compliant WFM configuration is assigned to the agent. In certain embodiments, once the WFM configuration is compliant, a work schedule is generated for the agent using the compliant WFM configuration and the details of the agent, and the work schedule is published for the agent.

At step 610d, LLM 122 generates one or more insights based on the compliance status.

At step 612, manager device 125 displays, on a WFM administrative interface, the compliance status of the first WFM configuration and the one or more insights based on the compliance status.

A specific example of the method 600 will now be described in detail. A supervisor created a WFM configuration for an agent in California, where the shift length is 10 hours, there are no defined breaks for a 9-hour shift, and weekly overtime is set to 50 hours. The workflow begins when California labor laws are retrieved using generative AI. California labor laws provide that the maximum shift length is 12 hours, there must be a 30-minute meal break after 5 hours and a 10-minute rest break every 4 hours, and the maximum weekly overtime is 20 hours. The shift length is compliant (10 hours<12 hours), breaks are non-compliant, and weekly overtime is non-compliant (50 hours>20 hours). The suggestions provided were to add a 30-minute meal break after 5 hours for shifts exceeding 9 hours and to reduce weekly allowed overtime to a maximum of 20 hours. The adjusted shifts and breaks were assigned to the agent, and the compliant schedule was published. This process ensures that agent schedules comply with local labor laws while maintaining operational efficiency.

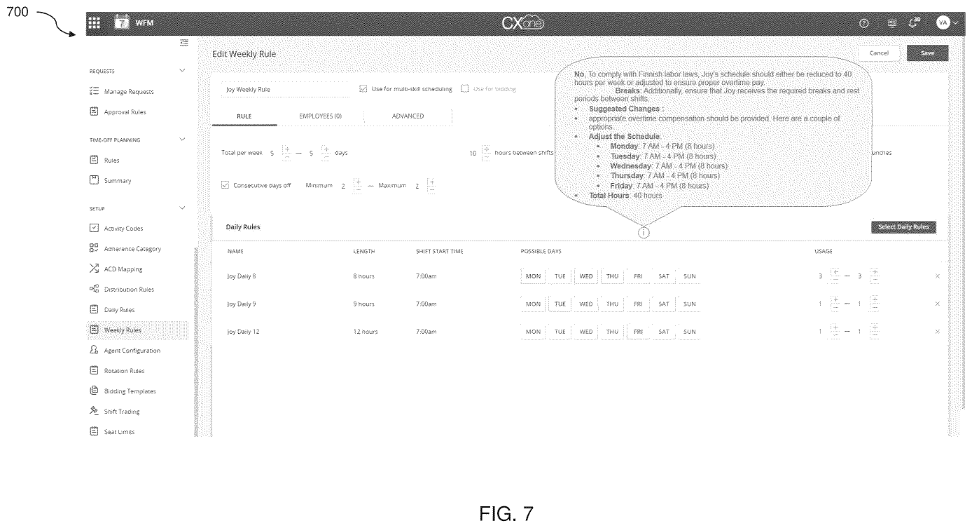

FIG. 7 provides a WFM administrative interface 700 according to embodiments of the present disclosure. The “Edit Weekly Rule” at the top left indicates that the user is configuring or modifying a scheduling rule for a specific period. The text field labeled “Joy Weekly Rule” represents the name of the weekly rule being edited or created. The rule name is editable, allowing customization for different needs. “Use for multi-skill scheduling” is checked and enables the weekly rule to be applied across multiple skills. The “Use for bidding” option is currently unchecked. It may allow employees to bid for shifts that adhere to this rule. The rule parameters include the “total per week” that is configured as 5 days, meaning the schedule spans 5 working days in a week. The “hours between shifts” is configured to 10 hours, ensuring compliance with rest period regulations between two shifts. “Consecutive days off” are configured as minimum 2 days and maximum 2 days. This parameter ensures employees get at least 2 consecutive days off.

In various embodiments, a “Daily Rules Table” allows configuration of daily schedules within the weekly rule. Table 1 below is a sample “Daily Rules Table.”

TABLE 1
DAILY RULES TABLE

| Column | Description |
|---|---|
| NAME | Lists the names of the daily rules (e.g., |
| | “Joy Daily 8”, “Joy Daily 9”, “Joy Daily 12”). |
| LENGTH | Specifies the duration of the shifts. For |
| | example: 8 hours, 9 hours, or 12 hours. |
| SHIFT START | Displays the start time for each shift. In this |
| TIME | case, all shifts start at 7:00 AM. |
| POSSIBLE DAYS | Allows selection of the days when each rule |
| | can be applied. Buttons for MON through |
| | SUN allow flexibility. |
| USAGE | Defines the number of times the rule can be |
| | used within the weekly schedule (e.g., 3 times, |
| | 1 time). |

As can be seen, each daily rule has a delete option (represented by an X on the far-right side) to remove rules if needed.

On the right, a pop-up appears to provide compliance guidance based on Finnish labor laws. It highlights the following:
1. Issue—The current schedule does not comply with labor laws due to excessive weekly working hours or improper overtime adjustments.
2. Breaks—The system recommends ensuring that the agent receives required rest and break periods between shifts.
3. Suggested Amendments—The system provides an alternative schedule that complies with labor laws:
   Monday: 7 AM-4 PM (8 hours)
   Tuesday: 7 AM-4 PM (8 hours)
   Wednesday: 7 AM-4 PM (8 hours)
   Thursday: 7 AM-4 PM (8 hours)
   Friday: 7 AM-4 PM (8 hours)
   Total Hours: 40 hours.
4. Action—the message offers actionable feedback for the user to adjust the schedule to meet legal requirements.

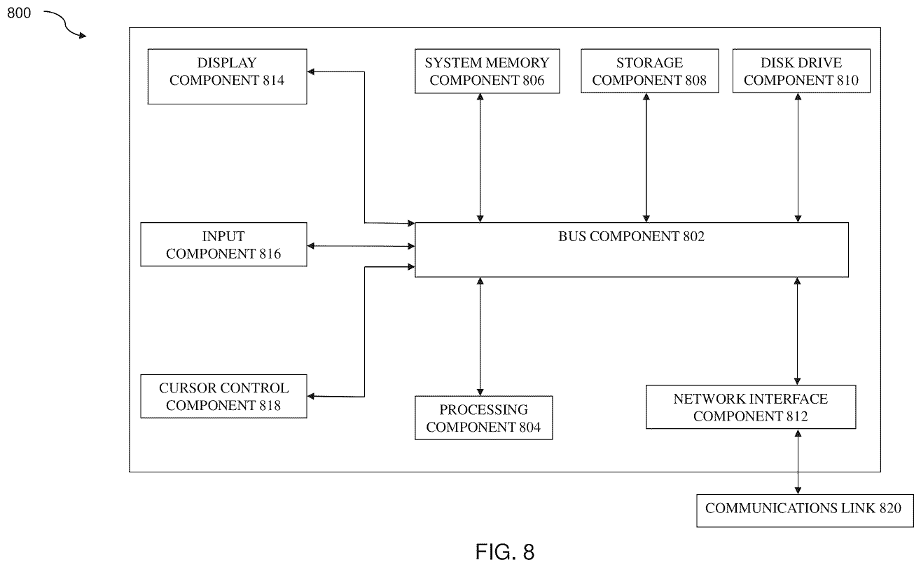

Referring now to FIG. 8, illustrated is a block diagram of a system 800 suitable for implementing embodiments of the present disclosure. System 800, such as part a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive a notification that a first workforce management (WFM) configuration for an agent was created or updated; retrieve details of the agent, the first WFM configuration of the agent, and a schedule unit of the agent; extract a geographic location of the agent from the schedule unit of the agent; generate a first prompt based on the geographic location of the agent and the first WFM configuration of the agent; execute the first prompt via a large language model (LLM) by: retrieving a set of labor compliance rules and regulations that apply to the geographic location of the agent, comparing the first WFM configuration of the agent against the set of labor compliance rules and regulations that apply to the geographic location of the agent, generating a compliance status of the first WFM configuration of the agent based on the comparison, and generating one or more insights based on the compliance status; and display, on a WFM administrative interface, the compliance status of the first WFM configuration and the one or more insights based on the compliance status. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A workforce compliance system comprising:
a processor and a non-transitory computer readable medium operably coupled thereto, the non-transitory computer readable medium comprising a plurality of instructions stored in association therewith that are accessible to, and executable by, the processor, to perform operations which comprise:
receiving a notification that a first workforce management (WFM) configuration for an agent was created or updated;
retrieving details of the agent, the first WFM configuration of the agent, and a schedule unit of the agent;
extracting a geographic location of the agent from the schedule unit of the agent;
generating a first prompt based on the geographic location of the agent and the first WFM configuration of the agent;
executing the first prompt via a large language model (LLM) by:
retrieving a set of labor compliance rules and regulations that apply to the geographic location of the agent,
comparing the first WFM configuration of the agent against the set of labor compliance rules and regulations that apply to the geographic location of the agent,
generating a compliance status of the first WFM configuration of the agent based on the comparison, and
generating one or more insights based on the compliance status; and
displaying, on a WFM administrative interface, the compliance status of the first WFM configuration and the one or more insights based on the compliance status.

2. The workforce compliance system of claim 1, wherein the compliance status comprises a non-compliant WFM configuration and the one or more insights based on the compliance status comprise a corrective action.

3. The workforce compliance system of claim 2, wherein the operations further comprise:
receiving a second WFM configuration of the agent that is based on the corrective action;
generating a second prompt from the geographic location of the agent and the second WFM configuration of the agent;
executing the second prompt via the LLM by:
comparing the second WFM configuration of the agent against the set of labor compliance rules and regulations that apply to the geographic location of the agent, and
validating that the second WFM configuration complies with the set of labor compliance rules and regulations that apply to the geographic location of the agent;
saving the second WFM configuration; and
assigning the second WFM configuration to the agent.

4. The workforce compliance system of claim 1, wherein the compliance status comprises a compliant WFM configuration, and the operations further comprise assigning the compliant WFM configuration to the agent.

5. The workforce compliance system of claim 4, wherein the operations further comprise:
generating a work schedule for the agent using the compliant WFM configuration and the details of the agent; and
publishing the work schedule for the agent.

6. The workforce compliance system of claim 1, wherein the first WFM configuration comprises daily work rules, weekly work rules, time-off rules, and extra-hours rules.

7. The workforce compliance system of claim 1, wherein the first prompt comprises a daily work rule or a weekly work rule from the first WFM configuration and the geographic location of the agent.

8. The workforce compliance system of claim 1, wherein the first prompt comprises a query regarding a maximum number of hours, breaks, and/or overtime for the geographic location of the agent.

9. A method for ensuring workforce compliance, which comprises:
receiving a notification that a first workforce management (WFM) configuration for an agent was created or updated;
retrieving details of the agent, the first WFM configuration of the agent, and a schedule unit of the agent;
extracting a geographic location of the agent from the schedule unit of the agent;
generating a first prompt based on the geographic location of the agent and the first WFM configuration of the agent;
executing the first prompt via a large language model (LLM) by:
retrieving a set of labor compliance rules and regulations that apply to the geographic location of the agent,
comparing the first WFM configuration of the agent against the set of labor compliance rules and regulations that apply to the geographic location of the agent,
generating a compliance status of the first WFM configuration of the agent based on the comparison, and
generating one or more insights based on the compliance status; and
displaying, on a WFM administrative interface, the compliance status of the first WFM configuration and the one or more insights based on the compliance status.

10. The method of claim 9, wherein the compliance status comprises a non-compliant WFM configuration and the one or more insights based on the compliance status comprise a corrective action.

11. The method of claim 10, which further comprises:
receiving a second WFM configuration of the agent that is based on the corrective action;
generating a second prompt from the geographic location of the agent and the second WFM configuration of the agent;
executing the second prompt via the LLM by:
comparing the second WFM configuration of the agent against the set of labor compliance rules and regulations that apply to the geographic location of the agent, and
validating that the second WFM configuration complies with the set of labor compliance rules and regulations that apply to the geographic location of the agent;
saving the second WFM configuration; and
assigning the second WFM configuration to the agent.

12. The method of claim 9, wherein the compliance status comprises a compliant WFM configuration, and the operations further comprise assigning the compliant WFM configuration to the agent.

13. The method of claim 12, which further comprises:
generating a work schedule for the agent using the compliant WFM configuration and the details of the agent; and
publishing the work schedule for the agent.

14. The method of claim 9, wherein the first prompt comprises a daily work rule or a weekly work rule from the first WFM configuration and the geographic location of the agent.

15. The method of claim 9, wherein the first prompt comprises a query regarding a maximum number of hours, breaks, and/or overtime for the geographic location of the agent.

16. A non-transitory computer-readable medium having stored thereon computer-readable instructions executable by a processor to perform operations which comprise:
receiving a notification that a first workforce management (WFM) configuration for an agent was created or updated;
retrieving details of the agent, the first WFM configuration of the agent, and a schedule unit of the agent;
extracting a geographic location of the agent from the schedule unit of the agent;
generating a first prompt based on the geographic location of the agent and the first WFM configuration of the agent;
executing the first prompt via a large language model (LLM) by:
retrieving a set of labor compliance rules and regulations that apply to the geographic location of the agent,
comparing the first WFM configuration of the agent against the set of labor compliance rules and regulations that apply to the geographic location of the agent,
generating a compliance status of the first WFM configuration of the agent based on the comparison, and
generating one or more insights based on the compliance status; and
displaying, on a WFM administrative interface, the compliance status of the first WFM configuration and the one or more insights based on the compliance status.

17. The non-transitory computer-readable medium of claim 16, wherein the compliance status comprises a non-compliant WFM configuration and the one or more insights based on the compliance status comprise a corrective action.

18. The non-transitory computer-readable medium of claim 17, wherein the operations further comprise:
receiving a second WFM configuration of the agent that is based on the corrective action;
generating a second prompt from the geographic location of the agent and the second WFM configuration of the agent;
executing the second prompt via the LLM by:
comparing the second WFM configuration of the agent against the set of labor compliance rules and regulations that apply to the geographic location of the agent, and
validating that the second WFM configuration complies with the set of labor compliance rules and regulations that apply to the geographic location of the agent;
saving the second WFM configuration; and
assigning the second WFM configuration to the agent.

19. The non-transitory computer-readable medium of claim 16, wherein the compliance status comprises a compliant WFM configuration, and the operations further comprise assigning the compliant WFM configuration to the agent.

20. The non-transitory computer-readable medium of claim 19, wherein the operations further comprise:
generating a work schedule for the agent using the compliant WFM configuration and the details of the agent; and
publishing the work schedule for the agent.
